(19) United States
(12) Patent Application Publication
(10) Pub. No.: US 2005/0045715 A1
(43) Pub. Date: Mar. 3, 2005

(54) Apparatus and method for tracking transaction card transactions

(76) Inventor: Brian Lombardino, Huntsville, AL (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/651,318

(22) Filed: Aug. 28, 2003

(51) Int. Cl. G06K 5/00

(52) U.S. Cl. 235/380

(57) ABSTRACT

An expense tracking apparatus comprising a transaction card and a label affixed to the transaction card, the label comprising a plurality of data fields for recording data defining a transaction, the data fields corresponding to the transaction card to which the label is affixed

### FIELD OF THE INVENTION

The present disclosure relates generally to the field of tracking transaction card expenses, and more particularly to recording data in real time on a transaction card related to individual transactions completed with a transaction card.

### BACKGROUND

An individual typically uses multiple transaction cards in their daily affairs. For example, an individual may carry transaction cards that include, such as, for example, a debit card, a revolving credit card, and/or a charge card. Note that a credit card typically refers to a card, on which the user can choose to retain a balance and pay an amount less than the balance owed. However, a charge card typically allows a carrier, i.e., the person to whom the card was issued, to carry a balance throughout a certain period, such as, for example, a month. Thus, the carrier is obligated under the terms and conditions of a contract that the carrier typically enters with an issuer of the card, e.g., a bank, to pay off the balance of the card.

Typically, a transaction card has a billing cycle, e.g., thirty days. Hence, during each billing cycle, each transaction completed is recorded by the issuer or an agent of the issuer either by receipt electronically, i.e., via an electronic transaction card approval device or via a computing device attached to a network, of data related to each transaction in which a particular transaction card is used. At the end of the billing cycle, i.e., at the end of each month, the issuer sends a statement to the carrier. Such statement usually identifies the data related to each transaction, e.g., the name of store/restaurant where transaction took place, the date of the transaction, the amount of the transaction.

In addition, the statement often includes other data related to the transaction card. For example, the statement may include the transaction card's current balance, the current interest rate charged for a continuing balance, and the total amount of the transactions for the billing cycle.

Oftentimes, the carrier is unaware throughout the month how many transactions he/she has completed, the amount of each transaction completed, and the total of all the transactions that have been completed for a billing cycle. In addition, the carrier may be unaware throughout the month of the current available credit in light of any maximum limits set by the issuer in the contract described herein.

### SUMMARY OF THE INVENTION

Generally, the present disclosure pertains to an expense tracking apparatus and method for recording real time data related to individual transaction card transactions.

An exemplary embodiment of the present disclosure is an expense tracking apparatus that comprises a transaction card and a label affixed to the transaction card, the label comprising a plurality of data fields for recording data defining a transaction, the data fields corresponding to the transaction card to which the label is affixed.

Another exemplary embodiment of the present disclosure encompasses a method for expense tracking, comprising the steps of affixing a label to a transaction card; recording data indicative of a transaction in which the transaction card is used on the label; calculating a new balance related to the transaction card by using a current balance recorded on the label and the data indicative of the transaction; and removing the label from the transaction card.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the invention. Furthermore, like reference numerals designate corresponding parts throughout the several views.

FIG. 1A depicts a front view of a transaction card.

FIG. 1B depicts the back view of the transaction card.

FIG. 2A depicts an expense tracking label of an exemplary embodiment of the present disclosure.

FIG. 2B depicts a back view of the expense tracking label of FIG. 2A.

FIG. 3 depicts the back of the transaction card of FIG. 1B with an expense tracking label of FIG. 2A affixed thereto.

FIG. 4 illustrates an exemplary architecture and functionality of an expense tracking method of the present disclosure.

### DETAILED DESCRIPTION

Generally, an embodiment of the present invention pertains to recording data related to individual transactions for which a particular transaction card is used. Such recordation provides a carrier of the transaction card the ability to track each transaction performed via the transaction card in real time and calculate a current balance in light of each individual transaction. More specifically, an exemplary embodiment of the present disclosure provides a transaction tracking label that affixes to the transaction card and that enables a carrier of the transaction card to record transaction data. Such recordation can be effectuated, for example, by writing on the label with an ink pen or other writing implement.

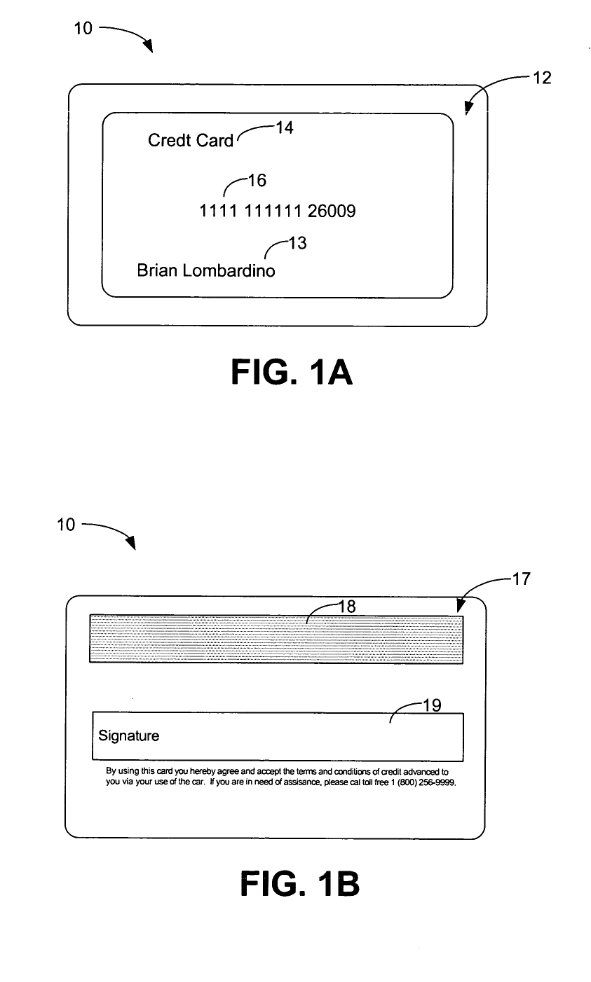

FIG. 1A depicts an exemplary front face 12 of a transaction card 10. The transaction card 10 comprises transaction card information 14, such as, for example, the issuer's identity. In addition, the front face 12 may further comprise a transaction card number 16 that is specific and unique for the carrier of the transaction card whose name 13 is specified on the front face 12, as well.

FIG. 1B depicts an exemplary back 17 of the transaction card 10 as depicted in FIG. 1A. The back 17 of the transaction card 10 comprises a portion 19 labeled signature in which the user preferably signs his/her name 13. In addition, the back 17 of the transaction card 10 preferably comprises a magnetic strip 18. The magnetic strip is used to electronically convey the transaction card number 16 to the device (not shown) for a transaction initiated by the user of the card.

During the course of use of the transaction card 10 to effectuate a transaction, the carrier presents the card to a person, for example a clerk at a retail store. The clerk can manually record the carrier's transaction card information, for example by writing on a charge slip the data indicative of the carrier's name 13, the transaction card information 14, and/or the transaction card number 16, which as described hereinabove is unique to the carrier. In addition, the clerk might manually record the information by using a manual imprint device that captures the transaction card information 14, the number 16 and the carrier's name. Further, the clerk or the carrier can swipe the transaction card 10 via an electronic capture device, which captures the data, for example the transaction card information 14, the transaction card number 16, and/or the carrier's name 13, via the magnetic strip 18 when the swipe is effectuated.

The captured information, whether it is captured manually via the transaction card slip or the imprint device or whether it is recorded electronically by swiping the magnetic strip 18 in an electronic capture device is then communicated to the issuer. The issuer compiles the captured information for each transaction that is completed during a billing cycle. Such captured and compiled information is then sent to the carrier at the end of each billing cycle in the form of a demand for payment.

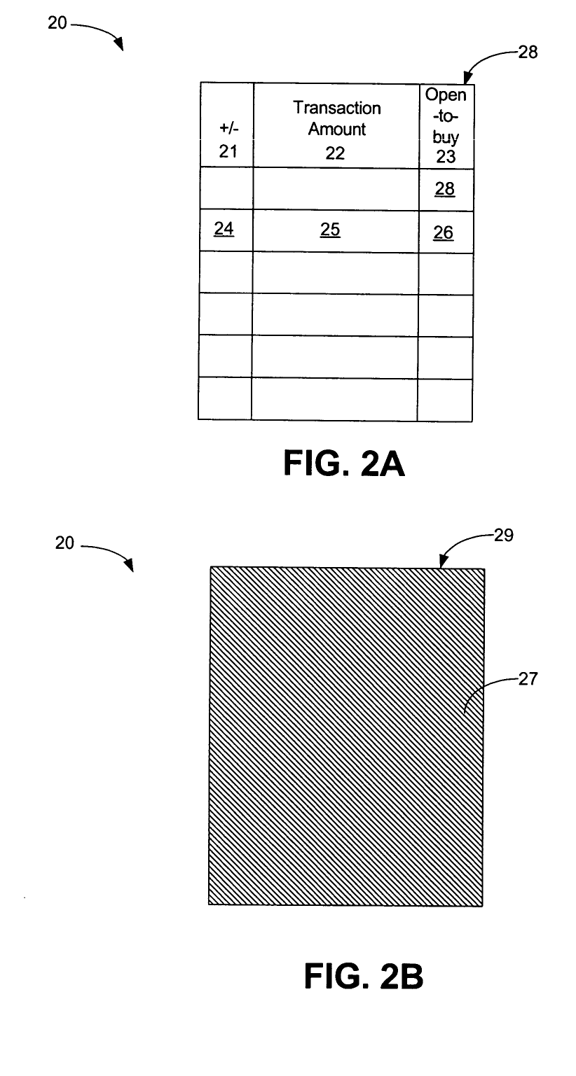

FIG. 2A depicts an exemplary expense tracking label 20 in accordance with the present disclosure. The label 20 preferably comprises a front 28, which exhibits a plurality of columns, e.g., 21-23, which represent exemplary types of data that a carrier may record on the particular label 20.

Label 20 comprises an exemplary debit/credit indication (+/−) column 21 for indicating whether a particular transaction entry is a debit or a credit transaction, i.e., whether the value associated with the entry is to be added to the current available credit or subtracted from the current available credit when determining the available credit total. Thus, a carrier preferably records in an entry field 24 associated with the +/−column 21 a marking, such as, for example, a “+” or a “−” indicating whether the entry associated with the entry field 24 is a debit or a credit.

In addition, the exemplary label 20 depicts transaction amount column 22 for recording data indicative of the dollar amount associated with the transaction, e.g., the cost of goods purchased with the transaction card or the cost of services purchased with the transaction card. Thus, a carrier preferably records in the transaction entry field 25 associated with the transaction amount column 22 a value indicative of the cost of the goods or services purchased with the card.

Moreover, the exemplary label 20 depicts an open-to-buy column 23 for recording data indicative of a running total associated with the card. In this regard, the running total can be a value indicating the current available credit associated with the card or it can be a total amount that has been put on the card during a particular period. Thus, a carrier may record the value provided in the last billing cycle statement provided by the issuer representative of the current available balance on the label 20. Thus, for each transaction amount recorded in an entry field 25, the carrier can subtract the amount recorded from the current available balance associated with the card to obtain a value indicative of the current available balance after the transaction for which data is recorded in the entry fields 23 and 25, and this obtained value can be recorded in entry field 26.

The total field could farther be used to record a running total of the transaction amounts recorded in entry field 25 for each billing cycle. In this regard, for each transaction the carrier may add, or subtract as indicated in entry field 24, from the previous total obtained in as a result of a previous transaction indicated in a previous entry field 26 the current transaction amount recorded in entry field 25 and record such total in an entry field 26 associated with the current transaction. In addition, the label 20 can comprise data field 28, which may be used to record an initial balance, for example, or it may be used for recording available credit.

FIG. 2B shows the back 29 of an exemplary expense tracking label 20 of FIG. 2A. The back 29 of the exemplary expense tracking label 20 preferably is coated with an adhesive 27. Initially, the label 20 may be releasably affixed to a page (not shown) of a plurality of labels 20 and the carrier can simply peel the label 20 from the page of labels for use with the transaction card 10. Note that in an exemplary embodiment the adhesive 27 that is used in affixing the label to the transaction card 10 may be formed such that it can be releasably affixed to the page of labels and to the transaction card 10, such that the label is disposable. In this regard, after the label's use, it can be removed from the transaction card 10 and thrown away. However, also note that the front 28 of the label 20 may be made of a more resilient material, such that a dry erase maker could be used to record data thereon. Therefore, the adhesive 27 does not necessarily have to be adapted for releasably affixing the label 20 to the transaction card 10. In other embodiments, the adhesive may be configured such that the label 20 can be more permanently affixed to the transaction card 10.

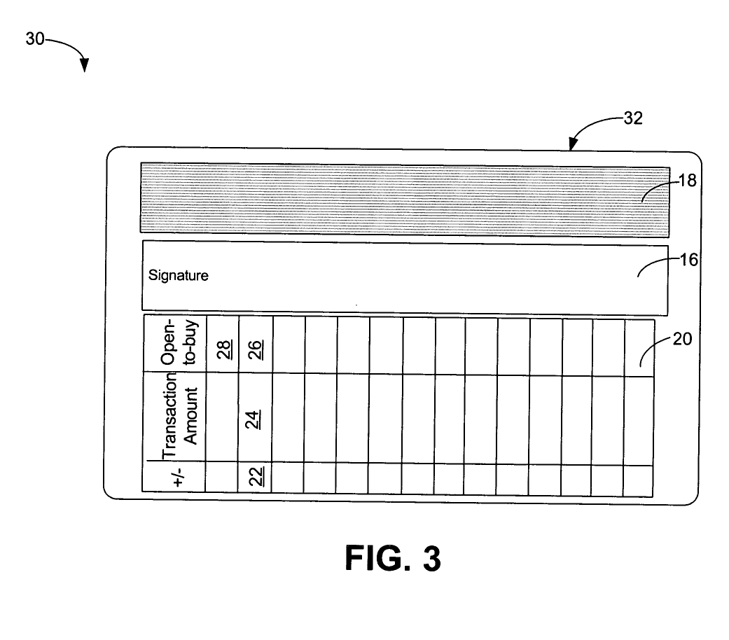

FIG. 3 depicts a back 32 of a transaction card 30, which has affixed thereto an exemplary label 20 of the present disclosure. The expense transaction label 20 is affixed to the back 32 of the transaction card 30 via the adhesive 27 (FIG. 2B). As described herein, a carrier may peel the label 20 from a page of labels (not shown), and such label 20 can be releasably affixed to the transaction card 30 or more permanently affixed to the transaction card 30 via a permanent adhesive.

Thus, a during the course of a carrier's day, he/she may retrieve the transaction card from a billfold or a purse and present the transaction card 30 to a clerk, for example, to use in completing a transaction, e.g., purchase of goods or services. During execution of the transaction, the carrier may record the transaction amount in entry field 24, indicate debit or credit in entry field 22, and calculate a total and record the total in entry field 26. Thus, a carrier knows per transaction a total corresponding to the transaction card 30 to which the label 20 is affixed.

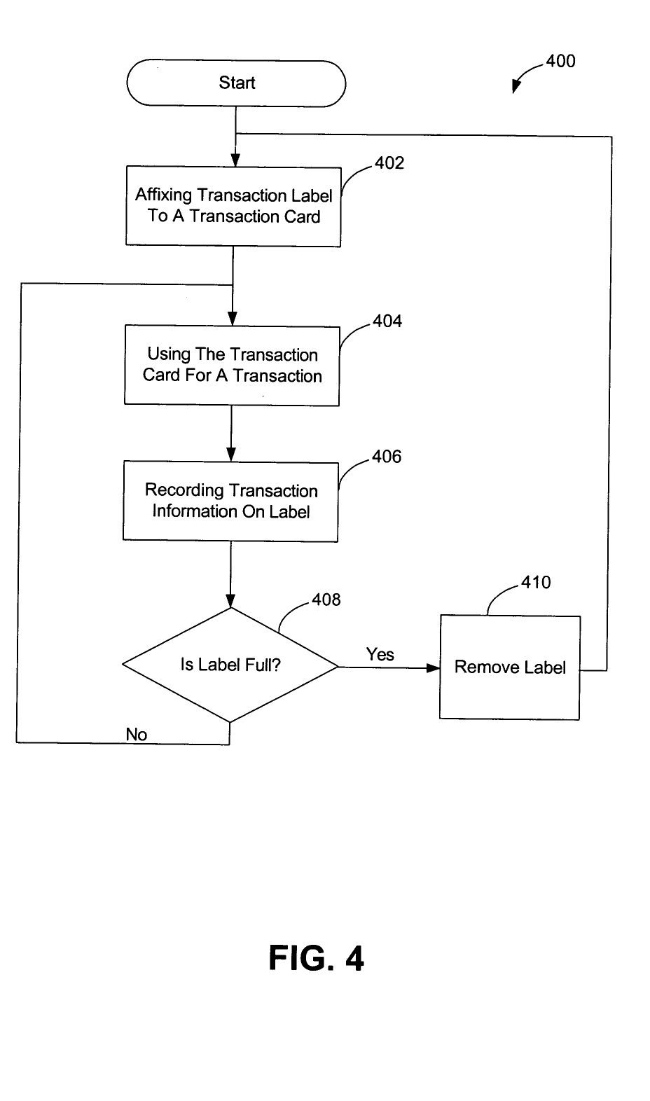

A method in accordance with an exemplary embodiment of the present disclosure is illustrated as the flowchart 400 in FIG. 4.

A carrier of the transaction card 30 (FIG. 3) affixes the expense tracking label 20 (FIG. 3) to the transaction card 30, as indicated in step 402. The expense tracking label can be attached via an adhesive as described herein either releasably or more permanently.

The carrier then uses the transaction card 30 (FIG. 3) to complete a transaction, as indicated in step 404. Preferably contemporaneously with using the transaction card 30 in the transaction or within a short period following completion of the transaction, the user records transaction information on the label 20 (FIG. 3), as indicated in step 406.

When each of the entry fields contains transaction information, as indicated in step 408, the user then removes the label 20, as indicated in step 410. The user then affixes a new expense tracking label to the transaction card 30 as indicated in step 402.

If the label is not full, as indicated in step 408, the user continues to use the card for recording transaction information in steps 404 through 406.

The carrier can further use the information recorded on the label 20 (FIG. 3) to reconcile his/her transaction card statement received after a billing cycle with the information recorded. The carrier can use this reconciliation to ensure that each transaction entered on the statement was in fact completed by the carrier and that each transaction amount associated with each transaction entered on the billing statement is accurate.

1. An expense tracking apparatus, comprising:
a transaction card;
a label affixed to the transaction card, the label comprising a plurality of data fields for recording data defining a transaction, the data fields corresponding to the transaction card to which the label is affixed.

2. The apparatus of claim 1, wherein the data fields comprise a debit/credit indication field, a transaction amount field, or an open-to-buy field.

3. The apparatus of claim 1, wherein the label is removeably affixed to the transaction card and wherein when each of the plurality of data fields has been used to record information, the label is configured for removing from the transaction card.

4. The apparatus of claim 1, wherein the label comprises a material adapted for recording data thereon with dry erase ink, such that when each of the plurality of data fields has been used the data recorded thereon can be erased.

5. A method for expense tracking, comprising the steps of:
affixing a label to a transaction card;
recording data indicative of a transaction in which the transaction card is used on the label;
calculating an open-to-buy amount related to the transaction card by using a current open-to-buy amount recorded on the label and the data indicative of the transaction; and
removing the label from the transaction card.

6. An expense tracking label, comprising:
a face adapted for writing thereon, the face comprising a plurality of data fields in which data related to a transaction card can be recorded; and
a back adapted for affixing to the transaction card such that when the back is affixed to the transaction card the face is positioned for writing thereon.

7. The label of claim 5, wherein the face is adapted for temporarily retaining the data related to the transaction card.

8. The label of claim 6, wherein the face is adapted for erasing the data when the data fields have been used.

9. The label of claim 6, wherein the back is further adapted for removeably affixing to the transaction card such that when the data fields have been used is can be removed and replaced.
